(19) United States
(12) Patent Application Publication
(10) Pub. No.: US 2026/0364551 A1
(43) Pub. Date: Nov. 19, 2026

(54) MICROMIXER, MICROPLATE, AND PROCESSING APPARATUS OF THE SAME

(71) Applicant: MYONGJI UNIVERSITY INDUSTRY AND ACADEMIA COOPERATION FOUNDATION, Yongin-si (KR)

(72) Inventors: Do hyun KIM, Seoul (KR); Ye Ji Yang, Anyang-si (KR); Hee Yeon KIM, Yongin-si (KR)

(73) Assignee: MYONGJI UNIVERSITY INDUSTRY AND ACADEMIA COOPERATION FOUNDATION, Yongin-si (KR)

(21) Appl. No.: 19/678,994

(22) Filed: May 15, 2026

(30) Foreign Application Priority Data
May 15, 2025 (KR) 10-2025-0063134
Dec. 17, 2025 (KR) 10-2025-0201438

(51) Int. Cl. B01F 33/30; B01F 31/44; B01F 35/71; B01F 101/23

(52) U.S. Cl. CPC B01F 33/3045; B01F 31/44; B01F 35/718051; B01F 2101/23

(57) ABSTRACT

A micromixer according to an embodiment of the present invention includes: a housing having an accommodation space in which a fluid is accommodated, a first opening hole exposed to the accommodation space, and a vibration space communicating with the first opening hole and configured to apply vibration to the accommodation space; and a vibration applying unit configured to apply vibration to the vibration space.

### CROSS-REFERENCE TO RELATED APPLICATION

This application claims priority to and the benefit of Korean Patent Application No. 10-2025-0063134 filed on May 15, 2025 and Korean Patent Application No. 10-2025-0201438 filed on Dec. 17, 2025, the disclosure of which is incorporated herein by reference in its entirety.

### BACKGROUND

### 1. Field of the Invention

The present invention relates to a micromixer, a microplate, and a Processing apparatus of the same capable of effectively mixing a fluid by efficiently applying vibration to a space in which the fluid is accommodated.

### 2. Discussion of Related Art

Various types of micro mixing devices are used for diagnostic biochips, DNA/RNA analysis, protein analysis, environmental analysis, nanoparticle synthesis, drug synthesis, isotope synthesis, mixing of reagents, sample pretreatment, enzyme reactions, and the like.

Micromixers may be classified into active micromixers, which utilize external energy such as acoustic waves, electric fields, magnetic fields, or heat for effective mixing, and passive micromixers, which induce mixing through a complicated channel structure and flow-rate control.

However, in general micromixers, even when the above-described methods are used, the fluid flow of has characteristics of laminar flow, and thus mixing is not sufficiently performed. Accordingly, various studies have been conducted to improve mixing performance.

Recently, in the fields of biochemistry, molecular biology, analytical chemistry, and pharmaceutical research, various types of microplates having a plurality of small wells arranged in a two-dimensional array have been used.

Various types of mixing devices that mechanically vibrate or stir a microplate to mix a fluid accommodated in wells of the microplate have been disclosed.

However, conventional mixing devices vibrate or stir an entire microplate, and thus there is a problem in that the fluid inside each of a plurality of wells is not sufficiently mixed.

In particular, when the size of a well is very small, it is difficult to uniformly mix the fluid in a narrow space using conventional microplate mixing devices.

Accordingly, there is a need for technology capable of promoting mixing of a fluid by directly applying an external force to the fluid positioned inside the well.

### RELATED ART DOCUMENT

### Patent Document

(Patent Document 1) Korean Patent Publication No. 10-2022-0010174

### SUMMARY OF THE INVENTION

The present invention has been made to solve the above problems, and an object of the present invention is to provide a micromixer, a microplate, and a processing apparatus thereoff, which can improve mixing performance of a fluid by effectively applying vibration to an accommodation space in which the fluid for mixing is accommodated.

The problem to be solved by the present invention is not limited to the above-described problems, and un-described problems will be clearly understood by those skilled in the art to which the present invention pertains from the present specification and the accompanying drawings.

A micromixer according to the present invention includes: a housing having an accommodation space in which a fluid is accommodated, a first opening hole exposed to the accommodation space, and a vibration space communicating with the first opening hole and configured to apply vibration to the accommodation space; and a vibration applying unit configured to apply vibration to the vibration space.

The micromixer may further include a shielding member configured to shield the first opening hole. The shielding member may be made of a material that expands and contracts by pressure applied to the vibration space, and the micromixer may further include a pressure adjusting unit configured to adjust pressure of the vibration space.

A plurality of vibration spaces may be provided, and pressures provided to the respective vibration spaces may be different from each other.

A second opening hole may be formed in the vibration space, and the micromixer may further include a valve configured to shield the second opening hole.

A microplate according to the present invention includes: a microplate body including one or more wells in which a first opening hole is formed; and a shielding member configured to shield the first opening hole.

The microplate may include a plurality of wells. The shielding member may include a first shielding member configured to shield a first opening hole formed in at least some of the plurality of wells and a second shielding member configured to shield a first opening hole formed in the remaining some of the plurality of wells, and the first shielding member and the second shielding member may have different degrees of stretchability.

The shielding member may include a protrusion protruding into the well.

The microplate may further include a support plate provided below the shielding member and having a second opening hole corresponding to the first opening hole.

The shielding member may be made of an elastic material.

An opening may be formed in the microplate body, and a magnet unit for applying magnetic field to a fluid accommodated in the well may be selectively positioned in the opening.

A processing apparatus according to the present invention includes: a body portion in which a space for accommodating an object to be processed is formed; and a vibration applying unit provided in the body portion and configured to apply vibration to the space.

The object to be processed may be a micromixer in which an accommodation space for accommodating a fluid, a first opening hole exposed to the accommodation space, and a vibration space communicating with the first opening hole and configured to apply vibration to the accommodation space are formed. The vibration applying unit may be formed to be exposed to the space of the body portion, and the micromixer may be coupled to the body portion so as to contact the vibration applying unit.

The processing apparatus may further include a pressure adjusting unit configured to adjust pressure of the vibration space. The processing apparatus may include a shielding member configured to shield the first opening hole, and the shielding member may be made of a material that expands and contracts by pressure of the vibration space adjusted through the pressure adjusting unit.

The object to be processed may be a microplate in which a plurality of wells are formed. The microplate may include a microplate body including one or more wells in which a first opening hole is formed, and a shielding member configured to shield the first opening hole. The accommodation space may include a mixing area for mixing a fluid accommodated in a well formed in the microplate, and the vibration applying unit may be provided in the mixing area.

A pressure adjusting unit configured to apply pressure to the shielding member may be provided in the mixing area.

The processing apparatus may further include a fixing unit provided in the mixing area and configured to fix the microplate.

The processing apparatus may further include a reading area for reading characteristics of the fluid accommodated in the well.

An opening may be formed in the microplate such that a magnet unit for applying magnetic field to the fluid accommodated in the well may be selectively positioned therein, and the processing apparatus may include a magnet plate including the magnet unit selectively positioned in the opening.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a micromixer according to a first embodiment of the present invention;

FIG. 2 is a cross-sectional view illustrating a state in which positive pressure is applied to the micromixer according to the first embodiment of the present invention;

FIG. 3 is a cross-sectional view illustrating a state in which negative pressure is applied to the micromixer according to the first embodiment of the present invention;

FIG. 4 is a view for explaining a process in which a fluid is mixed in the micromixer according to the first embodiment of the present invention;

FIG. 5 is a cross-sectional view of a micromixer according to a second embodiment of the present invention;

FIG. 6 is a cross-sectional view of a micromixer according to a third embodiment of the present invention;

FIG. 7 is a perspective view illustrating a processing apparatus according to a first embodiment of the present invention;

FIG. 8 is a view illustrating a lower surface of a micromixer coupled to the processing apparatus according to the first embodiment of the present invention;

FIG. 9 is a cross-sectional view of the processing apparatus according to the first embodiment of the present invention;

FIG. 10 is a view illustrating a state in which the micromixer is coupled to the processing apparatus according to the first embodiment of the present invention;

FIG. 11 is a perspective view of a processing apparatus according to a second embodiment of the present invention;

FIG. 12 is a perspective view of a microplate according to a first embodiment of the present invention;

FIG. 13 is a perspective view of a processing apparatus according to a third embodiment of the present invention;

FIG. 14 is a view for explaining a process in which a microplate is inserted into the processing apparatus according to the third embodiment of the present invention;

FIG. 15 is a view for explaining a state in which a microplate is seated in a mixing area of the processing apparatus according to the third embodiment of the present invention;

FIG. 16 is a view for explaining a state in which a microplate is seated in the mixing area of the processing apparatus according to the third embodiment of the present invention;

FIG. 17 is an enlarged partial view of FIG. 16;

FIG. 18 is a view for explaining mixing of a fluid inside a well in the mixing area of the processing apparatus according to the third embodiment of the present invention;

FIG. 19 is an exploded perspective view of a microplate according to a second embodiment of the present invention;

FIG. 20 is an enlarged view of a portion of the microplate according to the second embodiment of the present invention;

FIG. 21 is an exploded perspective view of a microplate according to a third embodiment of the present invention;

FIG. 22 is a cross-sectional view of the microplate according to the third embodiment of the present invention;

FIG. 23 is a perspective view of a microplate according to a fourth embodiment of the present invention;

FIG. 24 is a view for explaining a process of separating components in a fluid using a magnet in the processing apparatus according to the fourth embodiment of the present invention;

FIG. 25 is a view for explaining a portion inside a processing apparatus according to a fifth embodiment of the present invention; and

FIG. 26 is an exploded perspective view of the microplate according to the fourth embodiment of the present invention.

### DETAILED DESCRIPTION OF EXEMPLARY EMBODIMENTS

Hereinafter, detailed embodiments of the present invention will be described in detail with reference to the accompanying drawings. However, the spirit of the present invention is not limited to the presented embodiments, and those skilled in the art who understand the spirit of the present invention may easily propose other regressive inventions or other embodiments included in the scope of the present invention through addition, change, deletion, and the like of other components within the same scope of the spirit. However, these embodiments are also included in the scope of the present invention.

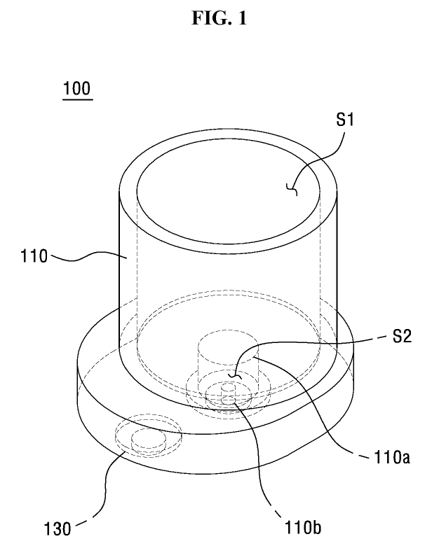

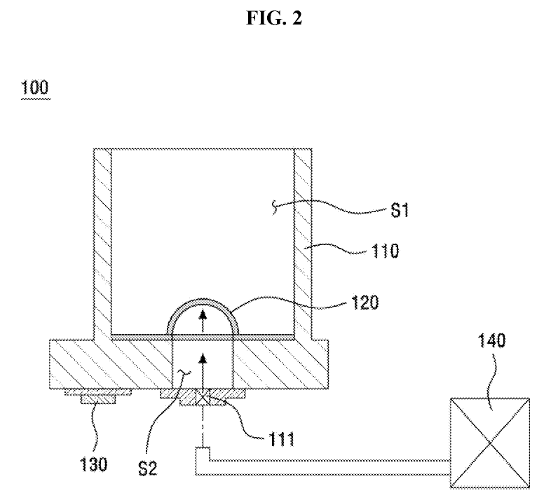

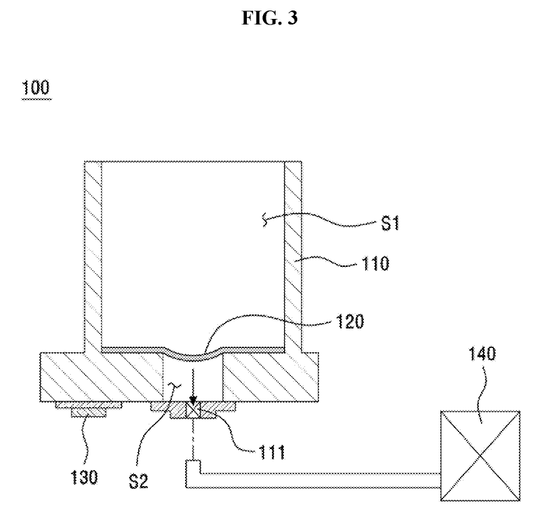

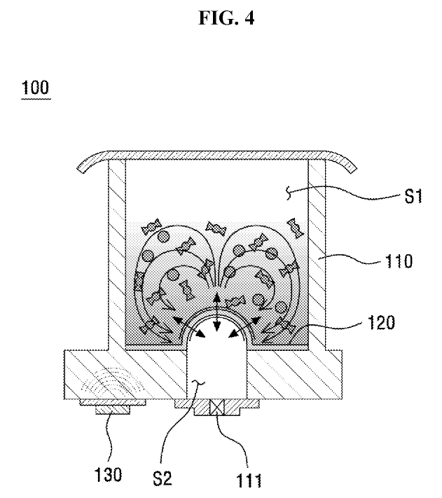

FIG. 1 is a perspective view of a microixer according to a first embodiment of the present invention. FIG. 2 is a cross-sectional view illustrating a state in which positive pressure is applied to the micromixer according to the first embodiment of the present invention. FIG. 3 is a cross-sectional view illustrating a state in which negative pressure is applied to the micromixer according to the first embodiment of the present invention. FIG. 4 is a view for explaining a process in which a fluid is mixed in the micromixer according to the first embodiment of the present invention.

Referring to FIGS. 1-4, the micromixer of the present invention is a device for mixing a fluid accommodated in a space by applying vibration to the fluid, and may be variously used for purposes such as diagnosis and treatment in the medical field, drug synthesis in the pharmaceutical field, protein analysis, RNA/DNA analysis, enzyme reaction research, protein crystallization in biotechnology and biology fields, and pollutant analysis in the environmental field.

The micromixer 100 according to the present embodiment includes a housing 110, a shielding member 120, a vibration applying unit 130, and a pressure adjusting unit 140.

The housing 110 includes an accommodation space S1 in which a fluid is accommodated, a first opening hole 110a exposed to the accommodation space S1, and a vibration space S2 communicating with the first opening hole 110a and configured to apply vibration to the accommodation space S1.

The positions and shapes of the accommodation space S1 and the vibration space S2 are not limited. In the present embodiment, however, a cylindrical accommodation space S1 is formed inside the housing 110 formed in a cylindrical shape. The vibration space S2 is disposed at the center of a lower portion of the accommodation space S1. The shape of the vibration space S2 is also not limited, but in the present embodiment, the vibration space S2 is formed in a cylindrical shape having a smaller volume than the housing.

The first opening hole 110a is formed at a boundary between the accommodation space S1 and the vibration space S2, and the shielding member 120, which will be described below, is provided in the first opening hole 110a.

A second opening hole 110b is formed in a lower portion of the vibration space S2, and a valve 111 for opening and closing the second opening hole 110b is provided. That is, when the valve 111 is closed, the vibration space S2 is sealed, and the pressure adjusting unit 140, which will be described below, is connected to the valve 111 so that pressure inside the vibration space S2 is adjusted.

The shielding member 120 shields the first opening hole 110a. The shielding member 120 may be made of a material capable of contracting or expanding by pressure applied from the pressure adjusting unit 140 described below. In the present embodiment, the shielding member 120 is made of PDMS, but silicone, latex, rubber, polyimide, PET, parylene, polyurethane, PEG, PPG, and the like may be used, without being limited thereto.

It is preferable that the shielding member 120 be formed to have an area larger than the first opening hole 110a and be fixed to an inner side surface of the accommodation space S1 so that the shielding member 120 is not separated during a pressure adjustment process by the pressure adjusting unit 140 or during vibration by the vibration applying unit 130.

That is, the vibration space S2 is shielded by the shielding member 120. Vibration generated by the vibration applying unit 130 described below is applied to a material located inside the vibration space S2, and the vibration is transmitted through the shielding member 120 to the fluid inside the accommodation space S1, thereby inducing mixing of the fluid.

Furthermore, as described below, when pressure is applied by the pressure adjusting unit 140 and the shielding member 120 expands toward the inside of the accommodation space S1, vibration may be transmitted to the fluid positioned inside the accommodation space S1 over a wider area.

Meanwhile, a gas supplied from the pressure adjusting unit 140 described below, that is, air, is accommodated in the vibration space S2. However, the present invention is not limited thereto, and various types of materials such as nitrogen, oxygen, helium, water vapor, and oil may be accommodated therein.

The vibration applying unit 130 applies vibration to the vibration space S2. Various components such as a motor, a solenoid, and a voice coil capable of applying vibration having various frequencies or waveforms may be used as the vibration applying unit 130, and in the present embodiment, a piezoelectric element is used to apply vibration to the vibration space S2.

The vibration applying unit 130 may be disposed at various points, such as a side surface or an upper end of the housing 110. In the present embodiment, the vibration applying unit 130 is attached to a lower portion of the housing 110 and transmits vibration to the vibration space S2. Meanwhile, a part of the vibration generated by the vibration applying unit 130 may be directly transmitted to the accommodation space S1.

The pressure adjusting unit 140 adjusts pressure inside the vibration space S2. The pressure adjusting unit 140 may be connected to the valve 111 provided at the lower portion of the vibration space S2 to adjust the pressure inside the vibration space S2. Specifically, when pressure is applied, the shielding member 120 expands toward the accommodation space S1 (see FIG. 2), and when negative pressure is applied, the shielding member 120 expands toward the vibration space S2 (see FIG. 3).

As illustrated in FIG. 4, the shielding member 120 vibrates finely or in a small amplitude according to vibration by the vibration applying unit 130, thereby inducing the fluid inside the accommodation space S1 to be mixed more effectively.

Furthermore, as the pressure adjusting unit 140 adjusts pressure, the expansion direction and the degree of expansion of the shielding member 120 can be controlled. Accordingly, monitoring of the mixing process can be performed while changing various conditions.

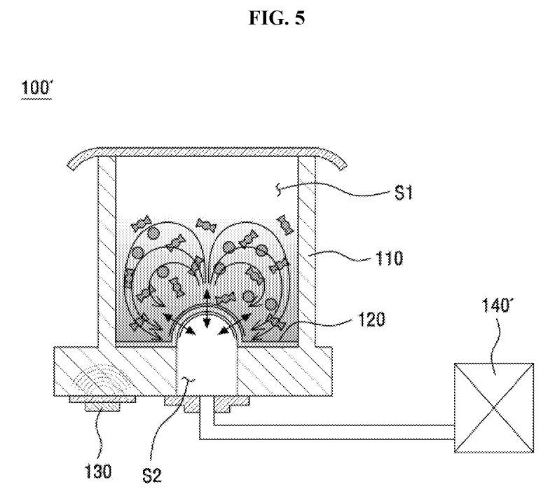

FIG. 5 is a cross-sectional view of a micromixer according to a second embodiment of the present invention.

Referring to FIG. 5, the overall configuration of the micromixer 100’ according to the present embodiment is similar to the embodiment described above, and differences will be mainly described below.

In the micromixer 100’ according to the present embodiment, a pressure adjusting unit 140’ is directly connected to the vibration space S2. Accordingly, pressure inside the vibration space S2 can be immediately adjusted. Furthermore, when positive pressure and negative pressure are repeatedly provided during the mixing process, the expansion direction of the shielding member 120 is changed, thereby enabling more effective mixing of the fluid.

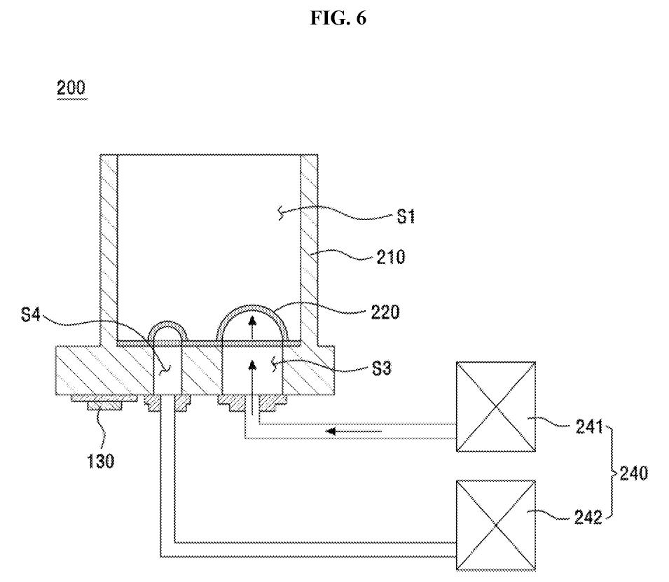

FIG. 6 is a cross-sectional view of a micromixer according to a third embodiment of the present invention.

Referring to FIG. 6, the overall configuration of the micromixer 100’ according to the present embodiment is similar to the embodiment described above, and differences will be mainly described below.

Two vibration spaces S3 and S4 are formed in the micromixer 200 according to the present embodiment.

The sizes and positions of the two vibration spaces S3 and S4 are not limited. In the present embodiment, two vibration spaces S3 and S4 having different sizes are formed in a lower portion of the housing 210 so as to communicate with a lower portion of the accommodation space S1.

One pressure adjusting unit 240 may adjust pressure of the two vibration spaces S3 and S4, or, as in the present embodiment, two pressure adjusting units 241 and 242 may individually adjust pressures of the two vibration spaces S3 and S4.

Accordingly, as illustrated, when positive pressure and negative pressure are provided in opposite directions, more effective mixing of the fluid can be induced.

Meanwhile, the shielding member 120 of the present embodiment is configured to shield upper portions of the two vibration spaces S3 and S4. However, two shielding members 120 may respectively shield upper portions of the two vibration spaces S3 and S4. Furthermore, when the two shielding members 120 are made of different types, for example, have different thicknesses, physical properties, or the like, more effective mixing can be induced.

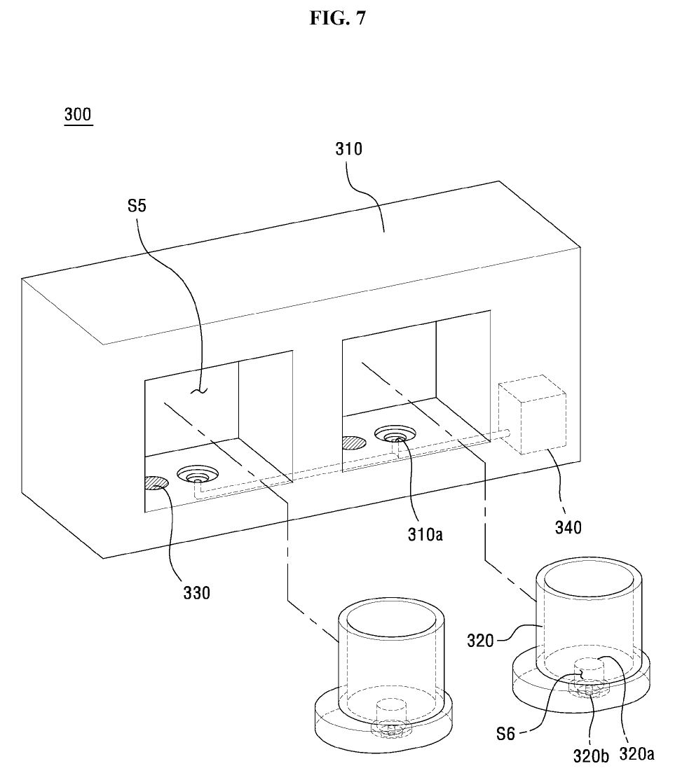

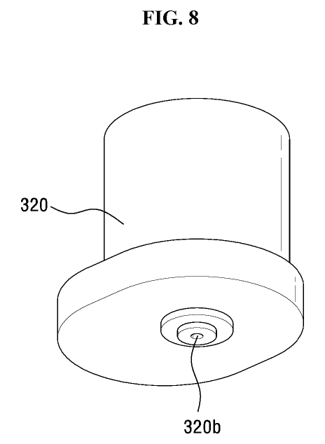

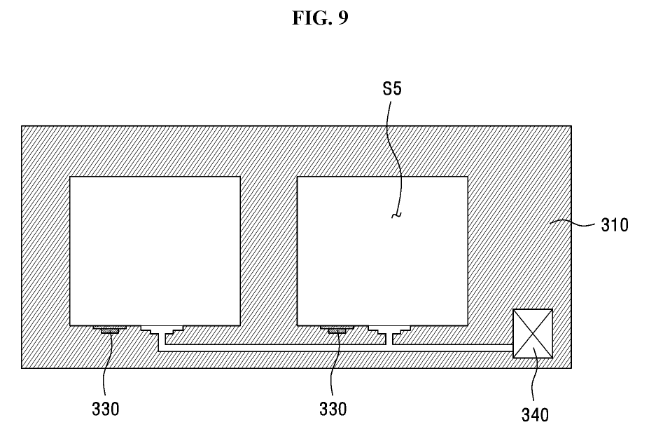

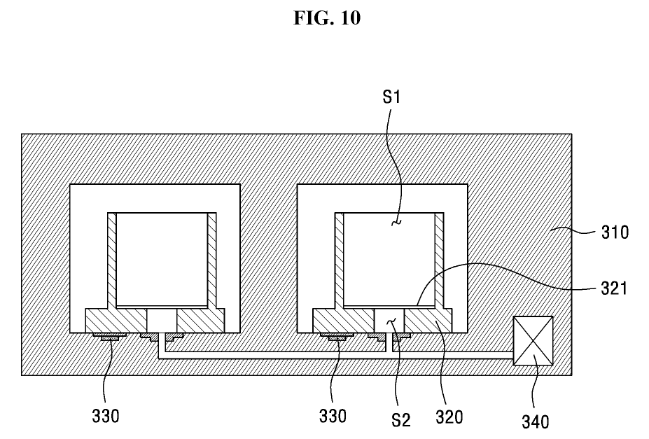

FIG. 7 is a perspective view illustrating a processing apparatus according to a first embodiment of the present invention. FIG. 8 is a view illustrating a lower surface of a micromixer coupled to the processing apparatus according to the first embodiment of the present invention. FIG. 9 is a cross-sectional view of the processing apparatus according to the first embodiment of the present invention. FIG. 10 is a view illustrating a state in which the micromixer is coupled to the processing apparatus according to the first embodiment of the present invention.

Referring to FIGS. 7-10, the processing apparatus according to the present embodiment is an apparatus to which a micromixer is coupled, and which applies vibration to the coupled micromixer and adjusts pressure in a vibration space of the micromixer.

Accordingly, when the micromixer of the present invention is used as a diagnostic kit or the like, a plurality of micromixers can be used to mix reagents, samples, and the like.

In addition, mixing operations can be performed on a plurality of micromixers under different conditions in the same environment.

Specifically, the processing apparatus 300 according to the present embodiment includes a body portion 310, a micromixer 320, a vibration applying unit 330, and a pressure adjusting unit 340.

A space S5 in which the micromixer 320 described below is accommodated is formed in the body portion 310. In the present embodiment, two spaces S5 are formed, but the number of spaces S5 is not limited.

A third opening hole 310a is formed in a bottom surface of the space S5. One end of the third opening hole 310a communicates with the micromixer 320 and a second opening hole 320b described below, and the other end of the third opening hole 310a communicates with the pressure adjusting unit 340 described below.

The vibration applying unit 330 described below is exposed on the bottom surface of the space S5.

The micromixer 320 includes an accommodation space S1 in which a fluid is accommodated, a first opening hole 320a exposed to the accommodation space S1, a vibration space S2 communicating with the first opening hole 320a and configured to apply vibration to the accommodation space S1, and a second opening hole 320b communicating with the vibration space S2.

The overall configuration of the micromixer 320 according to the present embodiment is different from the micromixer 100 according to the embodiment described above in that the vibration applying unit 130 and the pressure adjusting unit 140 are not provided therein.

As in the above embodiment, a shielding member 321 for shielding the first opening hole 320a is provided, and the shielding member 321 may be made of a material capable of expanding and contracting by pressure of the vibration space S2 adjusted through the pressure adjusting unit.

That is, in the present embodiment, the vibration applying unit 330 and the pressure adjusting unit 340 are provided in the body portion 310 as described above. After a user mounts the micromixer 320 in the space of the body portion 310, the vibration applying operation and pressure adjusting operation are performed on the micromixer 320.

The vibration applying unit 330 is provided in the body portion 310 and applies vibration to the vibration space S2. The vibration applying unit 330 may be formed at various positions capable of effectively applying vibration to the vibration space S2, and in the present embodiment, is formed to be exposed on the bottom surface of the space S5 of the body portion 310.

Accordingly, when the micromixer 320 is mounted in the space S5, the vibration applying unit 330 contacts a lower surface of the micromixer 320.

The pressure adjusting unit 340 adjusts pressure in the vibration space S2. Specifically, in the present embodiment, the pressure adjusting unit 340 is provided inside the body portion 310 and communicates with the third opening hole 310a exposed to an upper portion of the space S5.

Accordingly, when the micromixer 320 is disposed in the space S5, the second opening hole 320b of the micromixer 320 communicates with the third opening hole 310a of the space S5, and pressure inside the vibration space S2 is adjusted by operation of the pressure adjusting unit 340.

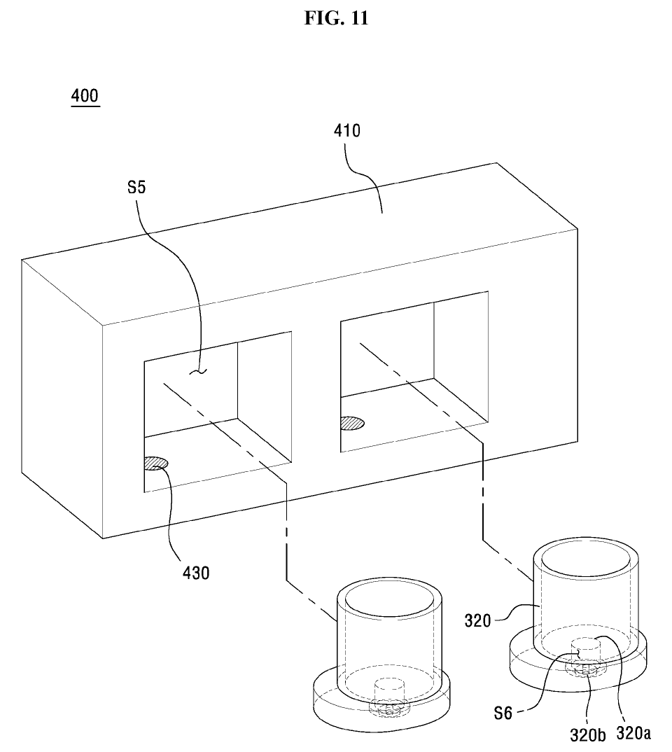

FIG. 11 is a perspective view of a processing apparatus according to a second embodiment of the present invention.

Referring to FIG. 11, the overall configuration of the processing apparatus according to the present embodiment is similar to the embodiment described above, and differences will be mainly described below.

The processing apparatus 400 according to the present embodiment includes a body portion 410 and a micromixer 320. The overall configuration of the micromixer 320 according to the present embodiment is similar to the micromixer 100 according to the first embodiment described above. That is, although not illustrated, a valve is provided below a vibration portion S6 of the vibration space, and a pressure adjusting unit may be selectively connected to the valve to determine pressure inside the vibration space S6.

A space S5 in which the micromixer 320 can be positioned is formed in the body portion 410, and a vibration applying unit 430 is exposed in the space S5.

That is, unlike the processing apparatus 300 of the above embodiment, the processing apparatus according to the present embodiment does not include a pressure adjusting unit in the body portion 410. That is, pressure inside the vibration portion S6 of the micromixer 320 is adjusted by a separate pressure adjusting unit (not shown), and thereafter mixing of the fluid is performed.

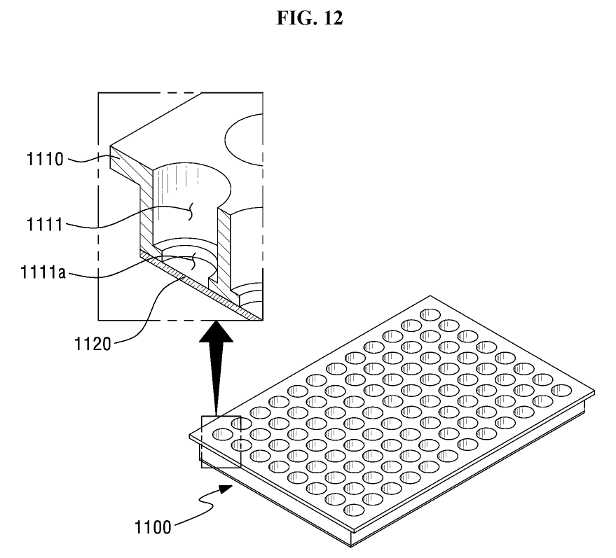

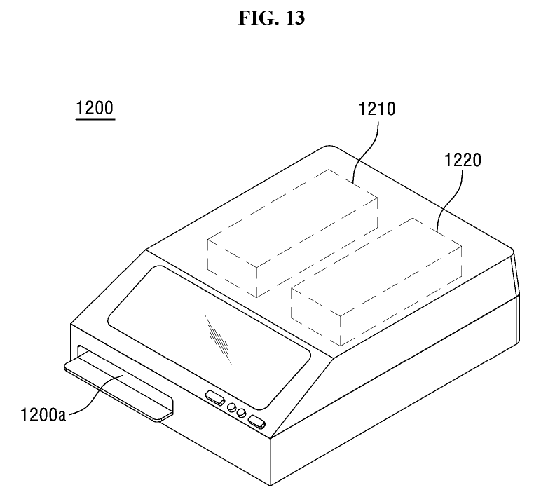

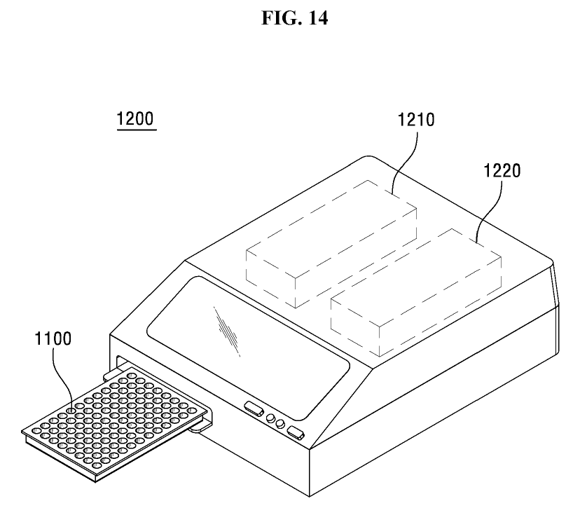

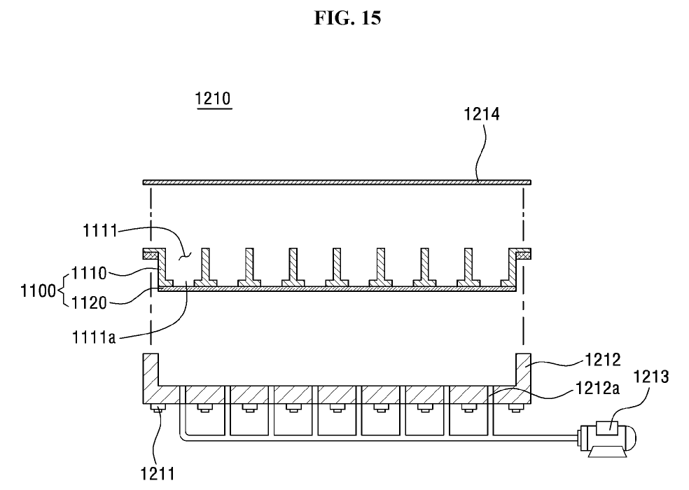

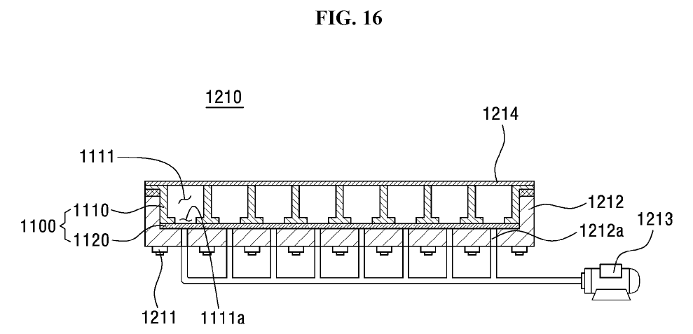

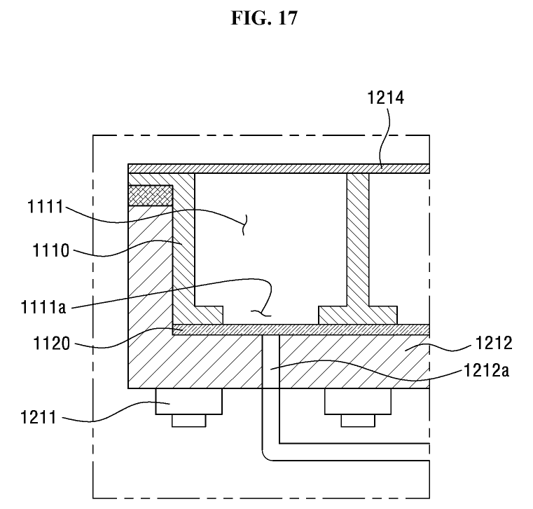

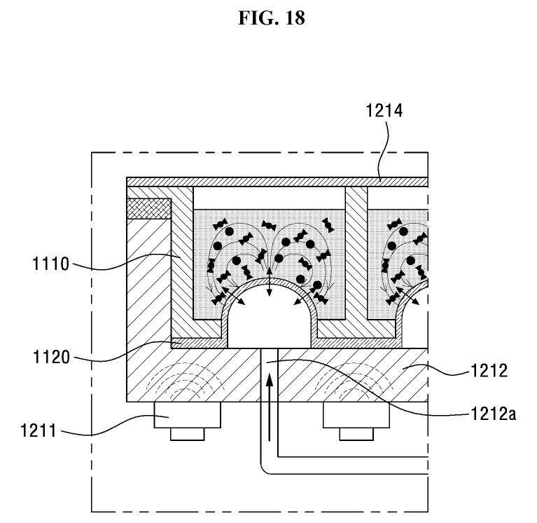

FIG. 12 is a perspective view of a microplate according to a first embodiment of the present invention. FIG. 13 is a perspective view of a microplate processing apparatus according to a first embodiment of the present invention. FIG. 14 is a view for explaining a process in which a microplate is inserted into the processing apparatus according to the third embodiment of the present invention. FIG. 15 is a view for explaining a state in which the microplate is seated in a mixing area of the processing apparatus according to the third embodiment of the present invention. FIG. 16 is a view for explaining a state in which the microplate is seated in the mixing area of the processing apparatus according to the third embodiment of the present invention. FIG. 17 is an enlarged partial view of FIG. 16. FIG. 18 is a view for explaining mixing of a fluid inside a well in the mixing area of the processing apparatus according to the third embodiment of the present invention.

Referring to FIGS. 12-18, the microplate 1100 according to the present embodiment includes a microplate body 1110 and a shielding member 1120.

A plurality of wells 1111 are formed in the microplate body 1110. The number of wells 1111 is not limited. In the present embodiment, description will be made based on a configuration in which a total of ninety-six wells 1111 are formed, with twelve wells arranged in each of eight rows.

A first opening hole 1111a is formed in each well 1111. The position of the first opening hole 1111a is not limited, and in the present embodiment, the first opening hole 1111a is formed in a bottom surface of the well 1111.

The shielding member 1120 shields the first opening hole 1111a. The shielding member 1120 may be formed to shield one opening hole 1111a, or may be formed to shield a plurality of first opening holes 1111a. The shielding member 1120 according to the present embodiment is formed to shield ninety-six first opening holes 1111a formed in bottom surfaces of the ninety-six wells 1111.

The shielding member 1120 may be made of a material capable of expanding or contracting by pressure applied from a pressure adjusting unit 1213 of a mixing area 1210 of a processing apparatus 1200 described below. In the present embodiment, the shielding member 1120 is made of PDMS, but silicone, latex, rubber, polyimide, PET, parylene, polyurethane, PEG, PPG, and the like may be used, without being limited thereto.

The processing apparatus 1200 according to the third embodiment of the present invention is an apparatus for performing processing such as mixing and reading with respect to the inserted microplate 1100.

That is, an insertion opening 1200a through which the microplate 1100 is inserted is formed in the processing apparatus 1200 according to the present embodiment, and a mixing area 1210 for mixing a fluid accommodated in the wells 1111 of the microplate 1100 and a reading area 1220 for measuring absorbance, fluorescence, luminescence, and the like of the fluid may be formed therein.

Furthermore, although not illustrated, known equipment for introducing a fluid, washing the microplate 1100, and the like may be additionally provided in the processing apparatus 1200.

Furthermore, various known methods and structures may be adopted for moving the microplate 1100 inserted through the insertion opening 1200a to the mixing area 1210 and the reading area 1220.

A vibration applying unit 1211 is provided in the mixing area 1210. Various components such as a motor, a solenoid, and a voice coil capable of applying vibration having various frequencies or waveforms may be used as the vibration applying unit 1211, and in the present embodiment, a piezoelectric element is used.

Specifically, the mixing area 1210 includes a base portion 1212 on which the microplate 1100 is seated, and the vibration applying unit 1211 is provided on a lower surface of the base portion 1212. The number of vibration applying units 1211 is not limited, and in the present embodiment, ninety-six vibration applying units 1211 are provided so as to correspond to the number of wells 1111.

A third opening hole 1212a is formed in the base portion 1212. The third opening holes 1212a are respectively formed at positions corresponding to lower portions of the wells 1111 and communicate with the pressure adjusting unit 1213 described below.

The pressure adjusting unit 1213 applies pressure to the shielding member 1120. Specifically, a fluid having a predetermined pressure is transmitted from the pressure adjusting unit 1213 to the shielding member 1120 through the third opening holes 1212a, and as illustrated in FIG. 18, the shielding member 1120 expands into the wells 1111. Various known pumps may be used as the pressure adjusting unit 1213.

Meanwhile, a fixing unit 1214 for fixing the microplate 1110 is provided in the mixing area 1210. The fixing unit 1214 according to the present embodiment is formed in a plate shape capable of covering an upper portion of the microplate 1110, and fixes the microplate 1110 to the base portion 1212.

In the reading area 1220, characteristics of the fluid accommodated in the wells 1111 are read. Various known devices for measuring absorbance, fluorescence, luminescence, and the like of the fluid may be provided in the reading area 1220.

Hereinafter, a method of processing the microplate 1100 through the processing apparatus 1200 according to the present embodiment will be described.

A user inserts the microplate 1100, into which a fluid to be processed has been introduced into the wells 1111, through the insertion opening 1200a of the processing apparatus 1200. The microplate 1100 moves to the mixing area 1210 of the processing apparatus 1200, is seated on the base portion 1212, and the fixing unit 1214 fixes the microplate 1100.

When pressure is applied by the pressure adjusting unit 1213, pressure is applied to the shielding member 1120, and the elastic shielding member 1120 expands upward through the first opening hole 1111a.

When the vibration applying unit 1211 applies vibration while the shielding member 1120 is expanded inside the wells 1111, the shielding member 1120 vibrates finely or in a small amplitude as illustrated in FIG. 18 and mixes the fluid inside the wells 1111.

Furthermore, when the pressure applied by the pressure adjusting unit 1213 is adjusted while the shielding member 1120 is expanded, the degree of expansion of the shielding member 1120 is varied, thereby inducing mixing of the fluid.

Meanwhile, when mixing is completed, the microplate 1100 is moved to the reading area 1220, and characteristics of the fluid are analyzed.

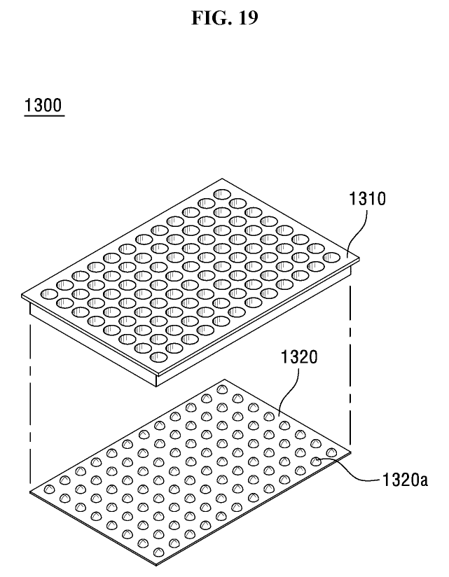

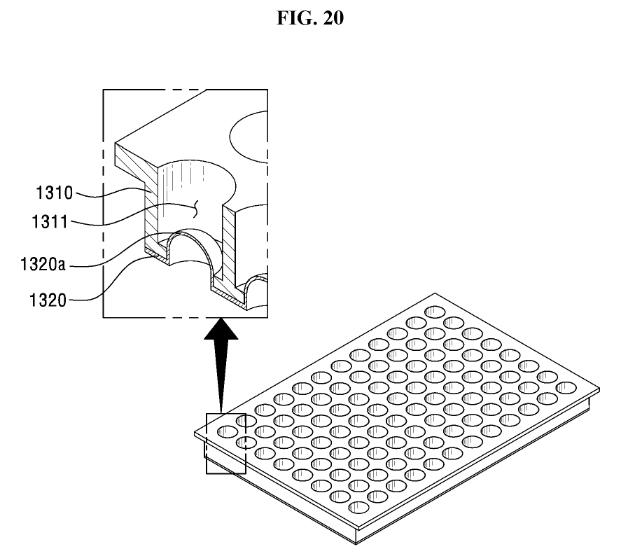

FIG. 19 is an exploded perspective view of a microplate 1300 according to a second embodiment of the present invention, and FIG. 20 is an enlarged view of a portion of the microplate according to the second embodiment of the present invention.

Referring to FIGS. 19 and 20, the overall configuration of the microplate 1300 according to the present embodiment is similar to the embodiment described above, and differences will be mainly described below.

The microplate 1300 according to the present embodiment includes a microplate body 1310 and a shielding member 1320.

The overall configuration of the microplate body 1310 is the same as that of the embodiment described above. The shielding member 1320 according to the present embodiment is also made of an elastic material as in the above embodiment, and includes a protrusion 1320a protruding so as to be positioned inside a well 1311.

Accordingly, even when the pressure adjusting unit 1213 does not expand the shielding member 1120 as in the above embodiment, the protrusion 1320a can be positioned inside the well 1311.

That is, the mixing area 1210 of the processing apparatus 1200 need not include the pressure adjusting unit 1213 and the opening holes 1212a of the base portion 1212.

Of course, the degree of expansion of the protrusion 1320a of the shielding member 1320 may be adjusted through the configuration of the pressure adjusting unit 1213.

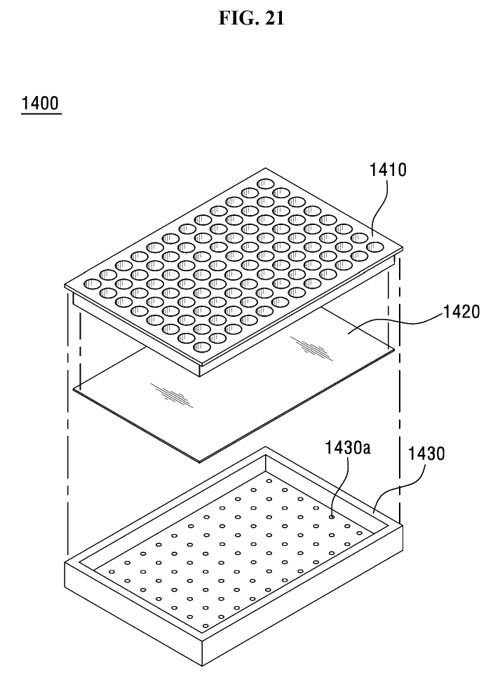

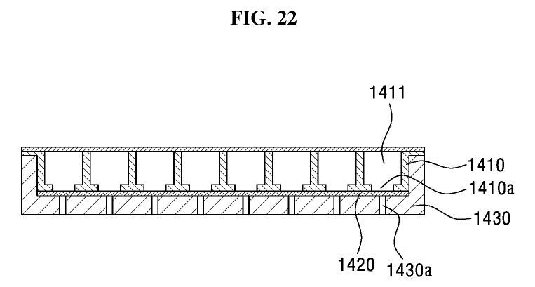

FIG. 21 is an exploded perspective view of a microplate according to a third embodiment of the present invention, and FIG. 22 is a cross-sectional view of the microplate according to the third embodiment of the present invention.

Referring to FIGS. 21 and 22, the overall configuration of the microplate 1400 according to the present embodiment is similar to the embodiment described above, and differences will be mainly described below.

The microplate 1400 according to the present embodiment includes a microplate body 1410, a shielding member 1420, and a support plate 1430.

The overall configurations of the microplate body 1410 and the shielding member 1420 are the same as those of the first embodiment of the present invention described above.

In the present embodiment, the support plate 1430 is additionally provided, and a second opening hole 1430a corresponding to the first opening hole 1410a is formed in the support plate 1430. Accordingly, the shielding member 1420 according to the present embodiment is stably fixed between the microplate body 1410 and the support plate 1430.

The shielding member 1420 expands into the well by the pressure of the fluid provided from the pressure adjusting unit 1213.

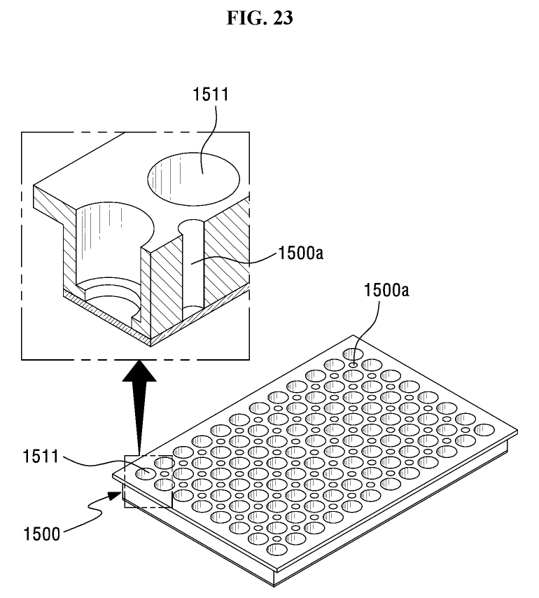

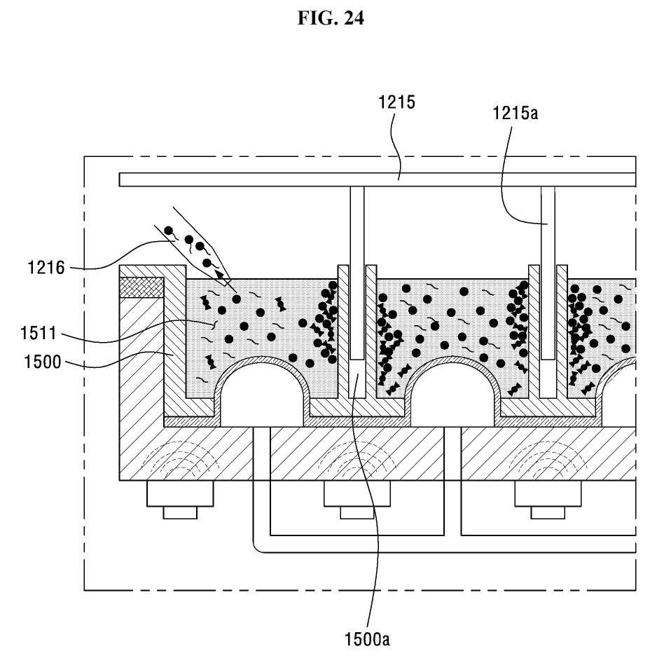

FIG. 23 is a perspective view of a microplate according to a fourth embodiment of the present invention, and FIG. 24 is a view for explaining a process of separating components in a fluid using a magnet in the processing apparatus according to the fourth embodiment of the present invention.

Referring to FIGS. 23 and 24, the overall configuration of the present embodiment is similar to the embodiment described above, and differences will be mainly described below.

In the microplate 1500 according to the present embodiment, openings 1500a may be formed, in which magnet units 1215a for applying magnetic force to a fluid accommodated in wells 1511 may be selectively positioned.

In general, magnetic beads may be used in a process such as DNA extraction. The magnet units 1215a according to the present embodiment perform a function of collecting magnetic beads in a DNA extraction process, and desired components of the fluid can be effectively extracted through extraction equipment 1216 while the magnetic beads are collected.

The openings 1500a may be formed at various positions of the microplate 1500 as long as magnetic force is applied to the fluid accommodated in the wells 1511. In the present embodiment, the openings 1500a are formed to be open at an upper surface of the microplate 1500.

Furthermore, the openings 1500a may be disposed between a plurality of wells 1511 to apply magnetic force to the plurality of wells. Specifically, in the present embodiment, an opening 1500a is formed between four wells 1511, and when a magnet unit 1215a is positioned in the opening 1500a, magnetic force is applied to the adjacent four wells 1511.

Meanwhile, the microplate processing apparatus according to the present embodiment includes a magnet plate 1215, and a plurality of magnet units 1215a that can be selectively positioned in the plurality of openings 1500a may be formed on the magnet plate 1215.

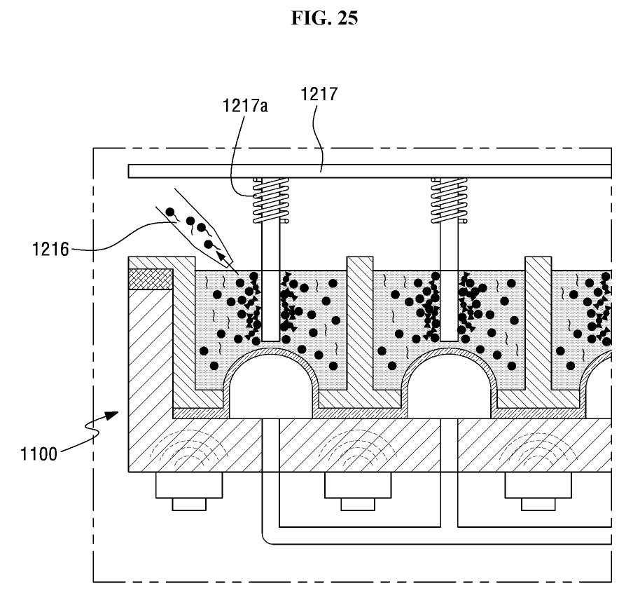

FIG. 25 is a view for explaining a portion inside a processing apparatus according to a fifth embodiment of the present invention.

Referring to FIG. 25, the magnet plate 1215 according to the present embodiment may be formed in the form of an electromagnet including a coil 1216. In the microplate according to the present embodiment, a magnet unit itself may be positioned inside a well without a separate opening, thereby collecting magnetic particles.

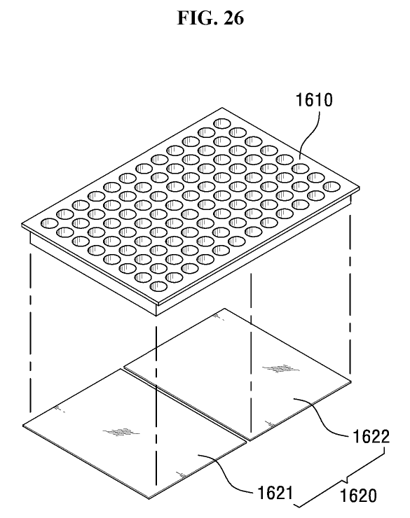

FIG. 26 is an exploded perspective view of the microplate according to the fourth embodiment of the present invention.

Referring to FIG. 26, the microplate 1600 according to the present embodiment includes a microplate body 1610 and a shielding member 1620. The shielding member 1620 according to the present embodiment includes a first shielding member 1621 configured to shield a first opening hole formed in at least some of the plurality of wells, and a second shielding member 1622 configured to shield a first opening hole formed in the remaining some of the plurality of wells.

The first shielding member 1621 and the second shielding member 1622 may be formed to have different stretchability. Specifically, the degrees of stretchability of the first shielding member 1621 and the second shielding member 1622 may be made different by using materials having different stretchability, or by forming the same material to have different thicknesses.

Accordingly, in the present embodiment, the degree of mixing can be controlled for selected wells in one microplate 1600.

A micromixer and a micro mixing apparatus including the same according to an embodiment of the present invention have the following effects.

First, there is an advantage in that vibration can be effectively applied to a space in which a fluid is mixed, thereby increasing mixing efficiency of the fluid.

Second, there is an advantage in that expansion and contraction of the shielding member can be controlled through the pressure adjusting unit, and mixing can be performed under various conditions.

The effects of the present invention are not limited to the above-described effects, and effects not mentioned herein will be clearly understood by those of ordinary skill in the art from the present specification and the accompanying drawings.

Although the configuration and features of the present invention have been described above based on embodiments according to the present invention, the present invention is not limited thereto, and it will be apparent to those skilled in the art that various changes or modifications can be made within the spirit and scope of the present invention. Therefore, such changes or modifications fall within the scope of the appended claims.

What is claimed is:

1. A micromixer comprising:
a housing having an accommodation space in which a fluid is accommodated, a first opening hole exposed to the accommodation space, and a vibration space communicating with the first opening hole and configured to apply vibration to the accommodation space; and
a vibration applying unit configured to apply vibration to the vibration space.

2. The micromixer of claim 1, further comprising a shielding member configured to shield the first opening hole.

3. The micromixer of claim 2, wherein the shielding member is made of a material that expands and contracts by pressure applied to the vibration space, and
the micromixer further comprises a pressure adjusting unit configured to adjust pressure of the vibration space.

4. The micromixer of claim 3, wherein a plurality of vibration spaces are provided, and
pressures provided to the respective vibration spaces are different from each other.

5. The micromixer of claim 1, wherein a second opening hole is formed in the vibration space, and
the micromixer further comprises a valve configured to shield the second opening hole.

6. A microplate comprising:
a microplate body including one or more wells in which a first opening hole is formed; and
a shielding member configured to shield the first opening hole.

7. The microplate of claim 6, wherein the microplate includes a plurality of wells,
wherein the shielding member includes a first shielding member configured to shield a first opening hole formed in at least some of the plurality of wells and a second shielding member configured to shield a first opening hole formed in a remaining some of the plurality of wells, and
wherein the first shielding member and the second shielding member have different degrees of stretchability.

8. The microplate of claim 6, wherein
the shielding member includes a protrusion protruding into the well.

9. The microplate of claim 6, further comprising a support plate provided below the shielding member and having a second opening hole corresponding to the first opening hole.

10. The microplate of claim 6, wherein the shielding member is made of an elastic material.

11. The microplate of claim 6, wherein an opening is formed in the microplate body, and a magnet unit for applying magnetic force to a fluid accommodated in the well is selectively positionable in the opening.

12. A processing apparatus comprising:
a body portion in which a space for accommodating an object to be processed is formed; and
a vibration applying unit provided in the body portion and configured to apply vibration to the space.

13. The processing apparatus of claim 12, wherein the object to be processed is a micromixer in which an accommodation space for accommodating a fluid, a first opening hole exposed to the accommodation space, and a vibration space communicating with the first opening hole and configured to apply vibration to the accommodation space are formed, and
wherein the vibration applying unit is formed to be exposed to the space of the body portion, and the micromixer is coupled to the body portion so as to contact the vibration applying unit.

14. The processing apparatus of claim 12, further comprising a pressure adjusting unit configured to adjust pressure of the vibration space.

15. The processing apparatus of claim 14, further comprising a shielding member configured to shield the first opening hole,
wherein the shielding member is made of a material that expands and contracts by pressure of the vibration space adjusted through the pressure adjusting unit.

16. The processing apparatus of claim 12, wherein the object to be processed is a microplate in which a plurality of wells are formed,
wherein the microplate includes a microplate body including one or more wells in which a first opening hole is formed, and a shielding member configured to shield the first opening hole,
wherein the accommodation space includes a mixing area for mixing a fluid accommodated in a well formed in the microplate, and
wherein the vibration applying unit is provided in the mixing area.

17. The processing apparatus of claim 16, wherein a pressure adjusting unit configured to apply pressure to the shielding member is provided in the mixing area.

18. The processing apparatus of claim 16, further comprising a fixing unit provided in the mixing area and configured to fix the microplate.

19. The processing apparatus of claim 16, further comprising a reading area configured to read characteristics of the fluid accommodated in the well.

20. The processing apparatus of claim 16, wherein an opening is formed in the microplate such that a magnet unit for applying magnetic field to the fluid accommodated in the well is selectively positionable therein, and
the processing apparatus comprises a magnet plate including the magnet unit selectively positioned in the opening.
